(19) United States
(12) Patent Application Publication
(10) Pub. No.: US 2020/0256435 A1
(43) Pub. Date: Aug. 13, 2020

(54) MOVEMENT TRANSFER MECHANISM, DRIVE ASSEMBLY COMPRISING A MOVEMENT TRANSFER MECHANISM AND A SYSTEM FOR GENERATING POWER FROM A PLURALITY OF LINEAR MOVEMENTS WITH THE MOVEMENT TRANSFER MECHANISM

(71) Applicant: ZIGRID AB, Nora (SE)

(72) Inventors: Torbjörn BIRGING, Storå (SE); Lars BIRGING, Huskvarna (SE); Jan BJÖRKMAN, Nora (SE)

(73) Assignee: ZIGRID AB, Nora (SE)

(21) Appl. No.: 16/760,300

(22) PCT Filed: Nov. 1, 2018
(86) PCT No.: PCT/SE2018/051119

§ 371 Date: Apr. 29, 2020

(30) Foreign Application Priority Data
Nov. 10, 2017 (SE) 1751390-4

(51) Int. Cl. F16H 19/04; F03B 13/18

(52) U.S. Cl. CPC F16H 19/043; F03B 13/186

(57) ABSTRACT

Disclosed is a movement transfer mechanism, a drive assembly and a system for transferring reciprocating linear movements into a rotary movement of a shaft. The transfer mechanism comprising a connecting member, first and second engaging means fixedly connected to the connecting member and first and second drive units, each comprising ball bearings with respective inner rings and outer rings, wherein the outer rings are fixedly attached to gear wheels. Each gear wheel is engaged with the respective engaging means. The invention is characterized by that the respective inner ring of the respective ball bearing is arranged to be fixedly connected to a first shaft, and further that the first drive unit and the second drive unit are arranged with a backstop and by that the respective outer ring is locked relative to the respective inner ring in a first rotational direction and unlocked in a second rotational direction which is an opposite direction relative to the first direction.

### TECHNICAL FIELD

Disclosed is a movement transfer mechanism for transferring a reciprocating linear movement of a reciprocating means into a rotary movement of a first shaft. Disclosed is further a drive assembly comprising such a movement transfer mechanism, as well as systems for generating power comprising such a drive mechanism,

### BACKGROUND ART

It is known to utilize energy from waves, pendulous motion, pistons, vibrations etc. by transferring this reciprocal linear movement into a rotary movement which is used to run a generator. The problem with utilizing energy from these kind of reciprocal linear motions is that the energy driving forces may vary in terms of size, intensity and direction. For example, waves tend to vary from no or small waves, to intense and high waves which makes it a challenge to utilize energy in an effective manner.

One solution is presented in CN 102011678, which relates to a device for energy generation by means of wave energy, The device has a float arranged on a pendulum arm which performs a reciprocating pendulum motion, which is transmitted to a rotational motion. This rotational motion alternates between a clockwise and counterclockwise motion. The forward and reverse movement of the pendulum is transmitted via a bevel gear to a gear wheel that drives an asynchronous motor. One disadvantage is that the rotational movement shifts direction, which means that some kind of gear must be used to cause one common motion, for example to drive a generator. The shifting motion will also cause increased wear of the device.

A better solution is presented in US 2013/0056988, which refers to a device for energy generation using wave energy. According to the invention, a first and second latch and wheel units with latches, wheels, gear wheels and shafts, are disclosed. The wave energy drives the device via gears wheels and rack members and provides a linear reciprocating motion which is then converted into a rotational motion of a common shaft. On the gear wheels locking latches are arranged, such that in a first linear direction of travel of the rack members, a drive of the gear wheels is achieved, and in a second opposite linear direction of movement of the rack members, the gear wheels run freely. The locking latches are arranged in such a way that the device is driven in both the first and second linear motion directions. The problem with this solution is that only one single reciprocating movement can supply a driving force to the driving shaft. This means that for example different wave intensity, wave height etc. will directly influence the rotation speed of the drive shaft and thus, there is no possibility to couple several such devices to drive a common drive shaft, to summarize different forces to act at a common drive shaft, If for example several devices as presented in FIGS. 1, 2 and 14a-d of US 2013/0056988, should be coupled to the same drive shaft, referenced as 10, 10′, 112, 112 in US 2013/0056988, and one of them would stop or change speed because of different wave height or similar, this one device will cause a braking force to the common drive shaft, and the system would not work.

Consequently, there is a need of a movement transfer mechanism that can sum up different forces from more than one irregular reciprocating linear movement into a common rotational movement

### SUMMARY OF THE INVENTION

It is an object of the invention to address at least some of the problems and issues outlined above. It is possible to achieve these objects and others by using an apparatus as defined in the attached independent claims.

According to an aspect of the invention, a movement transfer mechanism is provided, which is arranged for transferring a reciprocating linear movement of a reciprocating means into a rotary movement of a first shaft. The reciprocating linear movement may for example be driven by waves, pendulous motions, pistons, vibrations etc. The movement transfer mechanism comprising a connecting member, which is connected to the reciprocating means as to follow the reciprocating linear movement of the reciprocating means. Further, the movement mechanism comprises a first engaging means and a second engaging means, which are fixedly connected to the connecting member. The movement transfer mechanism further comprises a first drive unit and a second drive unit. The first drive unit comprises a first ball bearing and a first gear wheel, and the first ball bearing comprises an inner ring and an outer ring, wherein the outer ring is fixedly attached to the first gear wheel. The first gear wheel is in engaging contact with the first engaging means, and the first ball bearing is arranged with a backstop such that the outer ring is locked in one rotational direction relative the inner ring and unlocked in the opposite rotational direction relative the inner ring. The second drive unit comprises a second ball bearing and a second gear wheel, and the second ball bearing comprises an inner ring and an outer ring, wherein the outer ring is fixedly attached to the second gear wheel. The second gear wheel is in engaging contact with the second engaging means, and the second ball bearing is arranged with a backstop such that the outer ring of the second ball bearing is locked in one rotational direction relative the inner ring and unlocked in the opposite rotational direction relative the inner ring of the second ball bearing. The invention is characterized by that the respective inner ring of the respective ball bearing is arranged to be fixedly connected to the first shaft, and further that the first drive unit is locked in a first rotational direction and unlocked in a second rotational direction which is an opposite direction relative to the first direction. The second drive unit is arranged with its backstop in the same direction as the backstop of the first drive unit, such that the second drive unit is also locked in the first rotational direction and unlocked in the second rotational direction.

Such an arrangement does not only solve the problem of utilizing a power source like for example waves for transferring a linear movement of a reciprocating means to rotational motion of a shaft, but also makes it possible to take care of a plurality of linear movements, which even may be asynchronous linear movements, by coupling a plurality of such movement transfer mechanisms to a common first shaft, Further, by such an arrangement it is possible to add forces to the common first shaft in a controlled manner, for example by coupling/decoupling the reciprocating movement or control the rotational speed or force of the common shaft. Since the first shaft always can rotate because of the freewheeling of the drive units in the second rotational direction, that is the opposite direction relative the first rotating direction, i.e. the rotating direction of the first shaft, it is not affected by a stop of one or several of the plurality of linear movements, or the switching between one linear direction to the opposite linear direction. Thus, the impact of the force from the reciprocating linear movement to the shaft only contributes at the correct/wanted rotational speed of the shaft. This will be further explained below in relation to that particular embodiment. The same solution of the movement transfer mechanism also is a prerequisite for an “uncontrolled” adding of forces from a plurality of linear movements/asynchronous linear movements to drive the common first shaft. With “uncontrolled” is meant that the rotational speed of the shaft is not limited by for example a braking force. This since the direction of the linear movement always drives the shaft in one direction, and the linear movement only contributes to the speed of the shaft when it is the highest speed, since all drive units connected to the common first shaft, except the driving one, are freewheeling until the driving rotational speed is reached. This will also be explained further below. Prior art solutions do not disclose movement transfer mechanisms which are able to both transfer linear movements in different directions to one rotational direction of a shaft and at the same time provide the possibility to take care of a plurality of asynchronous movements by connecting a plurality of such transfer mechanisms to a common shaft, for utilizing for example waves as a power source.

According to an embodiment the first and second engaging are separate engaging means, and are fixedly arranged at a distance from each other on the connecting member. Further, the first and the second drive units are arranged approximately with the same distance from each other on the first shaft as the distance between the first and second engaging means. By such an arrangement, the drive units are arranged one after another on the common first shaft, at a suitable distance from each other, and the position of the respective engaging means corresponds, at least approximately, with the respective drive unit. This is a simple, cost-effective and space-saving solution with few parts, compared to existing solutions.

According to another embodiment, the first engaging means is in engaging contact with the first gear wheel at least on one side of the first shaft, and the second engaging means is in engaging contact with the second gear wheel at least on the opposite side of the first shaft. Since the first engaging means is in contact with the first gear wheel, at least on one side, this means that a first linear movement, for example upwards, can be transferred to the first shaft by the engaging contact with the drive unit. And by the locking of the first drive unit in the first rotational direction, and the unlocked state in the opposite second rotational direction, the shaft will rotate only when the linear movement is in the correct direction, here exemplified with the upward linear movement, Further, since second engaging means is in contact with the second gear wheel, at least on the opposite side of the shaft compared to the engagement of the first engaging means/the first gear wheel, and by the locking of the second drive unit in the first rotational direction, and the unlocked state in the opposite rotational direction, the shaft will be driven by the second engaging means when the linear movement is in the opposite direction compared to the first linear movement, here exemplified with a downward linear movement, Compared to prior art, this is a simple solution for taking care of the linear movements in two opposite directions.

According to an embodiment, the connecting member is to be arranged on the reciprocating means perpendicular relative to the reciprocating linear movement of the reciprocating means. The connecting member may be designed as a plate-like member or as a frame-like member or the like, with an extension perpendicular to the reciprocating means. The connecting member has a width corresponding at least approximately with the diameter of at least one of the first gear wheel or second gear wheel. The diameter of the first and second gear wheels may be the same, but does not need to be the same, for example if different transmission ratio is wanted. By that, the width of the connecting member may approximately follow the diameter of the respective gear wheel. Thus, the first and second engaging means can be fixedly connected to the connecting member in corresponding positions for engaging with the respective gear wheel. The length of the connecting member corresponds at least approximately with the distance between the first and second engaging means, why the first and second engaging means can be fixedly connected to the connecting member in corresponding positions for engaging with the respective gear wheel along the first shaft. It is to be understood that the dimensions of the connecting member don't need to exactly follow the diameter of the gear wheels or the distance between the engaging means, but can vary around these dimensions for the best functional design. By this design of the connecting member, the reciprocating linear movement is transferred to the connecting member and further to the drive units and to a rotating movement of the first shaft.

According to another embodiment the first engaging means is designed as a first gear rack and the second engaging means is designed as a second gear rack. The first and the second gear rack is attached to the connecting member with one end and protruding perpendicularly from the connecting member in direction towards the first shaft. The gear racks are respectively in engaging contact with the respective gear wheel on respective sides of the shaft. Designing the engaging means as gear racks is a simple and cost-effective solution which is easy to maintenance and is reliable in operation.

According to a preferred embodiment, the first gear rack and the second gear rack each comprises a toothed side facing towards the first shaft, which respective toothed side is engaged with the respective gear wheel on opposite sides of the shaft, for driving the shaft in one common direction, The latter depending on which one of the drive units driving the shaft at the moment, i.e. depending on the direction of the reciprocating linear movement.

According to a preferred embodiment of the above described embodiment, the first and second gear racks are attached at respective diagonally opposite ends of the connecting member. The connecting member only must “carry” the respective gear rack, and as they are arranged at different sides of the first shaft and at a distance from each other, the connecting member doesn't need to have a wider spread than to fixedly connect the gear racks to the connecting member, why a positioning of the gear racks on opposing ends/corners of the connecting member is preferred.

According to another preferred embodiment, the first engaging means is designed as a first chain and the second engaging means is designed as a second chain. In this alternative, the respective first and second chains are in engaging contact with the respective first and second gear wheels, at least on one respective side of the shaft. In some solutions the “chain-solution” may be more appropriate than the gear rack solution, for example when more compact solutions may be needed. The total length of the chain alternative is more or less determined by the stroke of the reciprocating means. For the gear rack alternative, the total length is more or less twice the stroke of the reciprocating means. For large strokes or great reciprocating forces, the chain alternative provides a more robust and compact solution compared to the gear rack alternative.

According to a preferred embodiment of the chain alternative, a second and third shaft are arranged parallel with the first shaft. The second and third shafts are further arranged at a distance from the first shaft. The second shaft comprises a third gear wheel and the third shaft comprise a fourth gear wheel, and the gear wheels are rotatably arranged at the respective second and third shaft. The connecting member is arranged between the position of the first shaft and the position of the second/third shaft. Preferably the second and third shaft are arranged in line with each other. The first and second chains are fixedly connected to the connecting member and runs like continuous chains around the gear wheels. Thus, the first chain runs around the first and third gear wheels and the second chain runs around the second and fourth gear wheels.

According to a preferred embodiment of the above described embodiment, the first and second chains are attached at respective diagonally opposite ends of the connecting member. The connecting member only must connect to the ends of the respective chain, and as the chains are arranged to run around the gear wheels like continuous chains, the connecting member doesn't need to have a wider spread than to fixedly connect the chains to the connecting member.

According to an aspect of the invention a drive assembly is disclosed. The drive assembly comprises a first shaft and a first movement transfer mechanism, for transferring a reciprocating linear movement of a reciprocating means into a rotary movement of the first shaft, according to any of the earlier described embodiments. By having a complete drive assembly including both the shaft and the transfer mechanism, the system is scalable from transferring one or a plurality of asynchronous reciprocating linear movements.

According to a preferred embodiment of the drive assembly described above, it comprises at least one second movement transfer mechanism, connected to the first shaft. This means that one or several extra transfer mechanisms are connected to the common first shaft, for driving the same in one common direction, which makes it possible to take care of a plurality of linear movements, which even may be asynchronous linear movements. Further, by such an arrangement it is possible to add forces to the common first shaft in a controlled manner, for example by coupling/decoupling the reciprocating means or control the rotational speed of the common first shaft. In the case with several forces (reciprocating linear movements) connected to the common shaft, the respective backstop of the drive units discloses a new preferable function in the arrangement—irrespective of direction of the individual reciprocating linear movement, all drive units are freewheeling until the individual drive unit reaches the rotational speed of the shaft. This also implies that the reciprocating means driven by a power source moves “without” resistance until one drive unit reaches the speed of the shaft. The advantage of this is that one or several power sources may stand still without affecting the speed of the shaft. This of course presumes that several power sources are connected to the common shaft so that the rotation doesn't stop. Since the first shaft always can rotate because of the freewheeling of the drive units in the opposite direction, it is not affected by a stop of one or several of the plurality of linear movements, or the switching between one linear direction to the opposite linear direction. This also means that the impact of the force from the reciprocating linear movement to the shaft only contributes at the correct/wanted rotational speed of the shaft, as well as the power sources may have different and irregular patterns of movement and yet cooperate on the same shaft.

The same solution of the movement transfer mechanism also is a prerequisite for adding of forces from a plurality of linear movements/asynchronous linear movements to drive the common first shaft, when no load brakes the shaft rotation. This since the direction of the linear movement always driving the shaft in one direction, and the linear movement only contributes to the speed of the shaft when it is the highest speed, since all drive units connected to the common first shaft, except the driving one, are freewheeling until the driving rotational speed is reached.

Summarized, if there is no load at the common first shaft, that is that nothing brakes the rotation of the shaft, then the actual rotational speed is determined of the reciprocating movement which has the highest speed. If the shaft has a regulated load causing a constant rotational speed of the shaft, the sum of all forces will act on the shaft, regardless of whether the force from each power source varies. Such solutions may for example be used for producing electrical power from wave energy. Another example is to use the technique in a vehicle for example to maintain speed using the throttle or the cruise control. When the wanted speed is reached, the power source is switched off, and then switched on again if the speed tends to fall below the set value. The power sources in such an application can advantageously be given different power by shifting power and/or gearing to the shaft, Other examples could be to produce electrical power, to drive a vehicle, pump or a ship propeller etc.

Prior art solutions do not disclose arrangements which are able to both transfer linear movements in different directions to one rotational direction of a shaft and at the same time take care of a plurality of asynchronous movements by connecting a plurality of such transfer mechanisms to a common shaft.

According to an aspect of the invention, a system for generating power from a plurality of linear movements from a plurality of reciprocating means is disclosed. The system comprises a drive assembly according to the embodiments described above, a generator coupled to the first shaft and a control system for controlling the generator such that the revolutions per minute of the first shaft is kept within a predetermined span. The advantages of such a system is that the power output from the system is controlled, and since the speed of the shaft connected to the generator is controlled, the sum of all forces from the reciprocating means will act on the shaft, regardless of whether the force from each power source varies. By that, the problems of utilizing power from asynchronous forces is taken care of in a simple manner, which is not known before.

According to an alternative aspect of the invention, a system for generating power from a plurality of linear movements from a plurality of reciprocating means is disclosed. The system comprises a drive assembly according to the embodiments described above, activation means for activating and for stopping the movement of each individual reciprocating means, measuring means for measuring the revolutions per minute of the first shaft and a control system for controlling the movement of the reciprocating means, for example activating and stopping the movement, based on the results of the measurements performed by the measuring means. Such a solution can be used for example in a vehicle to individually control each piston, and switch on and off each piston, to keep a certain rotational speed or add/remove power sources depending on the needed power, It is also possible to combine this solution with a generator as described above. Another example is to use the invention in a system where energy is stored for use of driving the reciprocating means and for minimizing the energy consumption which is crucial to make the stored energy to last as long as possible or until more energy is added in the storage. One example could be a system with compressed air stored in a tank, where the compressed air drives for example six pistons at full power, thereby generating 60 kW electricity. If the actual need of electricity only is 20 kW, only the reciprocating motion from two pistons are needed to cover the need, whereby 4 pistons are disconnected. By that, the compressed air lasts three times longer. The connection means for disconnecting the reciprocating means may be all kinds of known connection means, for example mechanical engaging/disengaging means, electromagnetic coupling etc. for starting and stopping the reciprocating movement of the reciprocating means.

Further possible features and benefits of this solution will become apparent from the detailed description below.

### BRIEF DESCRIPTION OF DRAWINGS

The solution will now be described in more detail by means of exemplary embodiments and with reference to the accompanying drawings, in which:

FIG. 1 is a perspective view of one embodiment of a drive assembly according to the invention, comprising a shaft and a movement transfer mechanism, and which embodiment has a gear rack design.

FIG. 2 is a detail view of an upper part of the movement transfer mechanism according to FIG. 1.

FIG. 3 is a perspective view of a drive assembly according to FIG. 1-2, comprising a plurality of movement transfer mechanisms connected to a common shaft.

FIG. 4 is a perspective view of an alternative embodiment of the drive assembly which comprising chains instead of gear racks.

### DETAILED DESCRIPTION

Briefly described, a drive assembly is provided that gives a cost-efficient and well-functioning solution for transferring one or several reciprocating linear movements of one or more reciprocating means, into a rotary movement of a first shaft. The solution comprises one or several movement transfer mechanisms for the transfer of linear motion to rotation of the shaft, and the invention is able to transfer linear movements from different directions to one rotational direction of a shaft, and at the same time take care of a plurality of asynchronous movements by connecting a plurality of transfer mechanisms to the common shaft.

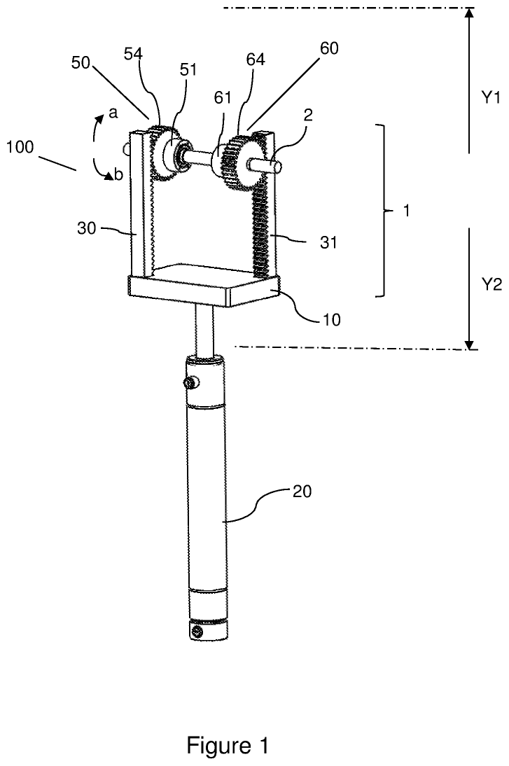

FIG. 1 shows a drive assembly 100, which comprises a movement transfer mechanism 1 and a first shaft 2. The movement transfer mechanism 1 comprises a connecting member 10, which is fixedly connected to a reciprocating means 20 so as to follow a reciprocating linear movement Y of the reciprocating means 20. The connecting member 10 is in this embodiment a plate with a substantially perpendicular extension relative to the reciprocating means 20. Further, the movement transfer mechanism 1 comprises first engaging means 30 and second engaging means 31, in the form of gear racks 30, 31, fixedly arranged at the connecting member, for example at respective diagonal ends or corners of the plate-shaped connecting member 10, and with an extension substantially parallel with the extension of the reciprocating means. The movement transfer mechanism 1 further comprises a first drive unit 50 and a second drive unit 60. The first drive unit 50 comprises a first ball bearing 51 and a first gear wheel 54, and the first ball bearing 51 comprises an inner ring 52 and an outer ring 53. The outer ring 53 is fixedly attached to the first gear wheel 54. The first gear wheel 54 is in engaging contact with the first gear rack 30, which means that when the first gear rack 30 moves for example upwards Y1, the first gear wheel 54 as well as the outer ring 53 moves in direction a. The first ball bearing 51 is arranged with a backstop such that the outer ring 53 is locked in one rotational direction, relative the inner ring 52 and unlocked in the opposite rotational direction, relative to the inner ring 52. This means that in the locked direction, the outer ring 53 will drive the inner ring 52 to rotate and by that also the first shaft 2. For example, if the first ball bearing 51 is locked in direction a, the first shaft 2 will be driven in the same direction a, while the outer ring 53 will run free and not drive the inner ring 52 in the unlocked direction b.

The second drive unit 60 comprises a second ball bearing 61 and a second gear wheel 64, and the second ball bearing 61 comprises an inner ring 62 and an outer ring 63. The outer ring 63 is fixedly attached to the second gear wheel 64. The second gear wheel 64 is in engaging contact with the second gear rack 31, which means that when the second gear rack 31 moves for example downwards Y2, the second gear wheel 64 as well as the outer ring 63 of the second gear wheel 64 moves in direction a. The second ball bearing 61 is arranged with a backstop such that the outer ring 63 of the second ball bearing 61 is locked in one rotational direction, relative the inner ring 62 and unlocked in the opposite rotational direction, relative the inner ring 62 of the second ball bearing 61. This means that in the locked direction, the outer ring 63 of the second gear wheel 64 will drive the inner ring 62 to rotate and by that also the first shaft 2. For example, if the second ball bearing 61 is locked in direction a, the first shaft 2 will be driven in the same direction a, while the outer ring 63 of the second gear wheel 64 will run free and not drive the inner ring 62 of the second gear wheel 64 in the unlocked direction b.

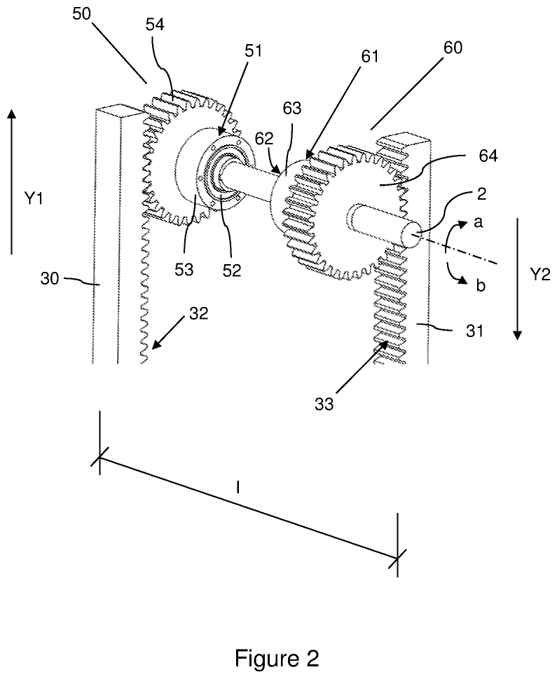

According to the invention, the respective inner ring 52, 62 of the respective ball bearing 51, 61 is arranged to be fixedly connected to the first shaft 2, and further that the first drive unit 50 is locked in the first rotational direction a, and unlocked in the second rotational direction b, which is an opposite direction relative to the first direction a. The second drive unit 60 is also arranged with its backstop in the same direction such that the second drive unit 60 is locked in the first rotational direction a, and unlocked in the second rotational direction b. With this constructional design the first shaft 2 is driven in the first rotational direction a, independently of whether the linear movement is going upwards Y1, referring to FIG. 1 or 2, or downwards Y2. In the solution, the first ball bearing 51 and the second ball bearing 61 are similar ball bearings, mounted on the common shaft 2 in the same direction after each other. The first gear wheel 54 and the second gear wheel 64 are attached to the respective ball bearing 51, 61 in reversed manner due to practical reasons. However, it is to be understood that the first drive unit 50 and the second drive unit 60 as well could be exact copies of each other, mounted in line and after each other on the shaft 2.

Referring to FIG. 2, which is a zoomed perspective view of the engagement between the gear racks 30, 31 and the gear wheels 54, 64, it can be seen that the first and second gear racks 30, 31 are separate gear racks, fixedly arranged at a distance I from each other on the connecting member 10. Corresponding to this distance I, the first and the second drive units 50, 60 are arranged approximately with the same distance I from each other on the first shaft 2. As seen in the figure, the first gear rack 30 is in engaging contact with the first gear wheel 54 at one side of the first shaft 2, while the second gear rack 31 is in engaging contact with the second gear wheel 64 the opposite side of the first shaft 2. Further, the respective gear rack 30, 31 comprises a respective toothed side 32, 33 facing towards the first shaft 2, which respective toothed side 32, 33 is engaged with the respective gear wheel 54, 64.

The respective gear racks 31, 31 are fixedly connected to the connecting member 10, and thus follows the reciprocating movement of the reciprocating means 20. The connecting member 10 is arranged perpendicular relative to the reciprocating linear movement of the reciprocating means 20, and the connecting member 10 has a width corresponding at least approximately with the diameter of at least one of the first gear wheel 54 or the second gear wheel 64, and a length corresponding at least approximately with the distance I between the first and second gear racks 30, 31.

As mentioned above, the inner rings 52, 62 of the first and second ball bearings 51, 61 is fixedly attached to the first shaft 2, and since the drive unit 50 has a backstop in one rotational direction a, and is free in the opposite rotational direction b, and the second drive unit 60 is arranged in the same way, the driving of the first shaft 2 in one single direction a is possible, regardless of the direction of the linear movement. So, if the linear movement is upwards Y1, referring to the figure, and the wanted rotational direction of the shaft is in the first direction a, the outer ring 53 of the first drive unit 50 is locked in the first direction a relative the inner ring 52, This means that the outer ring 53 drives the inner ring 52, and thus the first drive unit 50 is rotating in the first direction a and therefore drives the first shaft 2 in this direction, while the second drive unit 60 is rotating in the opposite direction b, and therefore is running free. And if the linear movement is downwards Y2, the outer ring 63 of the second drive unit 60 is locked in the first rotational direction a relative the inner ring 62 of the second drive unit 60, and therefore the second drive unit 60 is rotating in the first direction a and drives the first shaft 2 in this direction, while the first drive unit 50 is rotating in the opposite direction b, and therefore is running free.

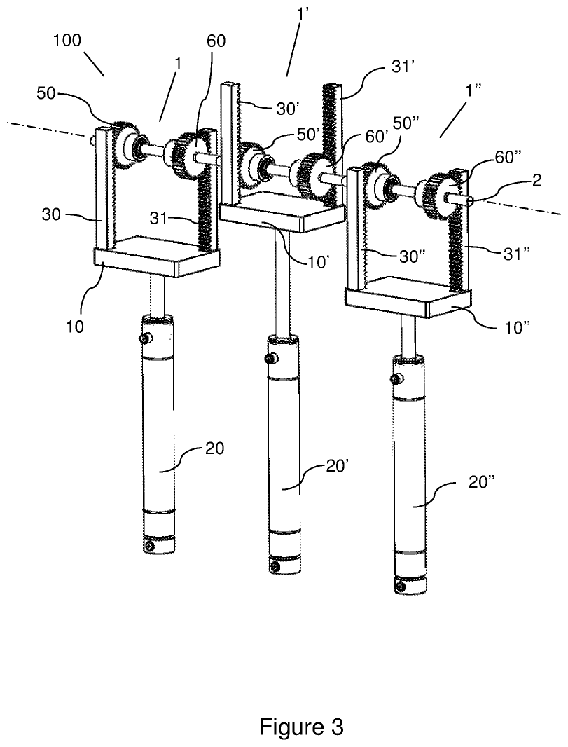

FIG. 3 shows the drive assembly 100 according to a preferred embodiment of the invention. This setup discloses a plurality of movement transfer mechanisms 1, 1′, 1″ arranged on a common first shaft 2. It should be mentioned that the common first shaft 2, instead could be a plurality of first shafts 2, connected at their ends to one common first shaft 2. The function of each individual movement transfer mechanism 1, 1′, 1″ is the same as described above. It can be understood by studying FIG. 3 and the above description of one individual transfer mechanism 1, 1′, 1″, that the reciprocating movement of the individual reciprocating means 20, 20′, 20″ is allowed to vary in terms of magnitude, speed, move or stand still, change direction (up/down) etc. without affecting each other, If the rotational speed of the first shaft 2 is uncontrolled, only the drive unit 50, 50′, 50″, 60, 60′, 60″ with the highest speed is driving the first shaft 2. Since all inner rings 52, 62, 52′, 62′, 52″, 62″ are rotating with the first shaft 2, each outer ring 53, 63, 53′, 63′, 53″, 63″ which not has reached the rotating speed of the shaft 2, relatively seen runs in the opposite direction relative to the respective inner ring, and thus, all drive units are in a freewheeling state relative to the first shaft 2, until reaching the highest speed. In this way, a number of asynchronous linear movement can be utilized for driving the first shaft 2. If the rotational speed of the first shaft 2 is controlled, for example by means of a generator and a control system, for keeping the speed at a certain level, or in a span, only the drive units 50, 50′, 50″, 60, 60′, 60″ which reaches the predetermined speed contributes to the driving force on the first shaft 2. By that, the driving arrangement 100 can be used as a self-regulating arrangement or a controlled arrangement with connecting/disconnecting of the reciprocating means 20, 20′, 20″ if wanted.

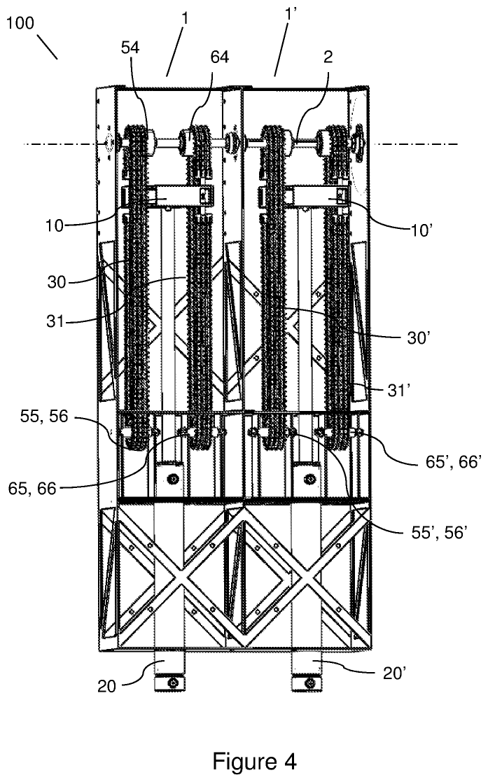

FIG. 4 shows an alternative embodiment of a drive assembly 100 compared with the earlier presented embodiment. In FIG. 4 this embodiment is exemplified with two movement transfer mechanisms 1, 1′, arranged on the common first shaft 2. Below, this embodiment will be described for one of these movement transfer mechanisms 1, to make the referring numbers clearer, but it is understood that the embodiment is scalable, as in the figure with two movement transfer mechanisms 1, 1′, or a plurality of movement transfer mechanisms 1, 1′, 1″. Therefore, the singular numbers referred to below should be understood to be plural numbers, by adding one or more apostrophes to the number, for example 30, 30′, etc.

According to this embodiment the first engaging means 30, is a first chain 30, and the second engaging means 31 is a second chain 31. In the illustrated example, the drive assembly 100 is mounted in a frame, which comprises a second and third shaft 55, 65, arranged parallel with the first shaft 2 at a distance from the same, in FIG. 4 below the connecting member 10. On the respective second and third shaft 55, 65, is a respective third and fourth gear wheel 56, 66, rotatably arranged. The first and second chains 30, 31 are attached with a respective first end on an upper side of the connecting member 10, which facing the first shaft 2. Further, the respective chain 30, 31, is running from the upper side of the connecting member 10, and further to the respective gear wheel 54. 64, and around the same approximately 180° and back in direction towards the connecting member 10 and also passing the same. The respective chain 30, 31 is further running to the respective third and fourth gear wheel 56, 66, and around the same approximately 180°, and back in direction towards the connecting member 10. Finally, the respective chain 30, 31 is attached with its second end on an underside of the connecting member 10, which underside facing the respective second and third 55. 65. By that, the respective chain is arranged like continuous chains attached at the connecting member 10 for driving the gear wheels 54, 64 in response to the reciprocating linear movement of the reciprocating means 20.

Although the description above contains a plurality of specificities, these should not be construed as limiting the scope of the concept described herein but as merely providing illustrations of some exemplifying embodiments of the described concept. It will be appreciated that the scope of the presently described concept fully encompasses other embodiments which may become obvious to those skilled in the art, and that the scope of the presently described concept is accordingly not to be limited. Reference to an element in the singular is not intended to mean “one and only one” unless explicitly so stated, but rather “one or more.” All structural and functional equivalents to the elements of the above-described embodiments that are known to those of ordinary skill in the art are expressly incorporated herein and are intended to be encompassed hereby.

1. A movement transfer mechanism for transferring a reciprocating linear movement of a reciprocating means into a rotary movement of a first shaft, the movement transfer mechanism comprising:
a connecting member to be connected to the reciprocating means so as to follow the reciprocating linear movement of the reciprocating means,
a first engaging means and a second engaging means fixedly connected to the connecting member,
a first drive unit comprising a first ball bearing and a first gear wheel, and the first ball bearing comprising an inner ring and an outer ring, wherein the outer ring is fixedly attached to the first gear wheel, and the first gear wheel is in engaging contact with the first engaging means, and the first ball bearing is arranged with a backstop such that the outer ring is locked in one rotational direction relative the inner ring and unlocked in the opposite rotational direction relative the inner ring,
a second drive unit comprising a second ball bearing and a second gear wheel, and the second ball bearing comprising an inner ring and an outer ring, wherein the outer ring of the second ball bearing is fixedly attached to the second gear wheel, and the second gear wheel is in engaging contact with the second engaging means, and the second ball bearing is arranged with a backstop such that the outer ring of the second ball bearing is locked in one rotational direction relative the inner ring of the second ball bearing, and unlocked in the opposite rotational direction relative the inner ring of the second ball bearing,
wherein the inner ring of the first ball bearing and the inner ring of the second ball bearing are arranged to be fixedly connected to the first shaft, and the outer ring of the of the first ball bearing is locked in a first rotational direction relative the inner ring, and unlocked in a second rotational direction which is an opposite direction relative to the first direction, and the outer ring of the second ball bearing is locked in the first rotational direction relative the inner ring of the second ball bearing, and unlocked in the second rotational direction and in that the first and second engaging means are separate engaging means, and are fixedly arranged at a distance from each other on the connecting member, and the first and the second drive units are arranged approximately with the same distance from each other on the first shaft as the distance between the first and second engaging means.

2. The movement transfer mechanism according to claim 1, wherein the first engaging means is in engaging contact with the first gear wheel at least on one side of the first shaft, and the second engaging means is in engaging contact with the second gear wheel at least on the opposite side of the first shaft.

3. The movement transfer mechanism according to claim 1, wherein the connecting member is to be arranged on the reciprocating means perpendicular relative to the reciprocating linear movement of the reciprocating means, and the connecting member has a width corresponding at least approximately with the diameter of at least one of the first gear wheel or second gear wheel, and a length corresponding at least approximately with the distance between the first and second engaging means.

4. The movement transfer mechanism according to claim 1, wherein the first engaging means is a first gear rack, and the second engaging means is a second gear rack.

5. The movement transfer mechanism according to claim 4, wherein the first gear rack and the second gear rack each comprises a toothed side facing towards the first shaft, which respective toothed side is engaged with the respective gear wheel.

6. The movement transfer mechanism according to claim 4, wherein the first and second gear racks are attached at respective diagonally opposite ends of the connecting member.

7. The movement transfer mechanism according to claim 1, wherein the first engaging means is a first chain, and the second engaging means is a second chain.

8. The movement transfer mechanism according to claim 7, wherein a second and third shaft are arranged parallel with the first shaft and at a distance from the same, and a respective third and fourth gear wheel are rotatably arranged at the respective second and third shaft, and the connecting member is arranged between the first shaft and the second/third shaft, and the first and second chains are fixedly connected to the connecting member and runs like continuous chains around the gear wheels, wherein the first chain is running around the first and third gear wheels and the second chain is running around the second and fourth gear wheels.

9. The movement transfer mechanism according to claim 7, wherein the respective chain is attached at respective diagonally opposite ends of the connecting member.

10. The drive assembly, comprising:
a first shaft, and
a first movement transfer mechanism for transferring a reciprocating linear movement of a reciprocating means into a rotary movement of the first shaft, according to claim 1.

11. The drive assembly according to claim 10, comprising at least one second movement transfer mechanism connected to the first shaft.

12. The system for generating power from a plurality of linear movements from a plurality of reciprocating means, comprising:
a drive assembly according to claim 10,
a generator coupled to the first shaft,
a control system for controlling the generator such that a number of revolutions per minute of the first shaft is kept within a predetermined span.

13. The system for generating power from a plurality of linear movements from a plurality of reciprocating means, comprising:
a drive assembly according to claim 10,
activation means for activating and for stopping the movement of each individual reciprocating means,
measuring means for measuring the number of revolutions per minute of the first shaft,
a control system for controlling the movement of the reciprocating means.
